(19) United States
(12) Patent Application Publication
(10) Pub. No.: US 2004/0000419 A1
(43) Pub. Date: Jan. 1, 2004

(54) Round cable tie mount for electrical wiring, cables and/or fiber optic links

(76) Inventor: Charles George Clendenen, Porter, TX (US)

Correspondence Address: NIXON & VANDERHYE P.C./G.E., 1100 N. GLEBE RD., SUITE 800, ARLINGTON, VA, 22201, US

(21) Appl. No.: 10/064,263

(22) Filed: Jun. 26, 2002

(51) Int. Cl. H02G 3/00

(52) U.S. Cl. 174/72 A

(57) ABSTRACT

A cable tie mount for routing wires or cables includes an elongated rail portion and at least one mounting stub at one end of the rail portion, at least one mounting stub extending substantially perpendicularly of the rail portion for securing the cable tie mount to a supporting surface.

### BACKGROUND OF INVENTION

This invention relates generally to cable routing and, specifically, to a cable tie mount to which electrical wiring, cables, fiber optic links and the like may be secured using conventional cable ties.

Cable ties (also known as tie wraps or lashing ties) have become increasingly popular in recent years as a mechanism for securing electrical wires to a sturdy supporting surface. Devices for securing the cable tie to a supporting surface are referred to as cable tie mounts. Cable tie mounts come in a variety of existing designs, all of which inherently restrict the number of cables which can be secured. Specifically, prior designs for cable tie mounts involve the use of flat or nearly flat tie down surfaces, which inherently restrict the number of cables which can be secured.

Conventional cable tie mounts are usually individually directly adhesively secured to the flat surface of, for example, an electrical panel, door, or similar flat surface. Self-adhesive used to secure the mounts often results in removal of paint from the panel or door surface that, in turn, causes the mount to separate from the surface.

In addition, making or stocking a large number of cable tie mount part numbers to accommodate different numbers of wires in a wiring loom or wiring bundle can be expensive, time consuming and a hindrance to efficient production.

### SUMMARY ON INVENTION

The cable tie mount in accordance with the invention is capable of supporting a greater range of cables, wires or fiber optic links than other designs. It can be made of tubing, bar stock, plastic, or other suitable material. It is bent or formed into a U-shape at each end and is then affixed to a supporting surface. The method of attachment for a cable tie mount made of metal tubing is typically by threading the ends and using screws, but fusion welding may also be employed. For a round cable tie mount made of bar stock, the typical method of attachment is by fusion welding. When using plastics, the method of attachment is typically by bonding or via the use of an appropriate glue.

After installation, electrical wires may be lashed to the cable tie mount using conventional tie wraps or lashing ties (cable ties). The cable tie mount can be made in various sizes to accommodate large and small cables, wires and fiber optic links alike. A cable tie mount in accordance with this invention can accommodate a single wire lashed to it with a cable tie, up to a multitude of wires which completely encircle the mount.

The cable tie mount described herein offers a more universal and generic design which accommodates a much greater range in the number of wires, cables or fiber optic links (all of which are referred to herein simply as “cables”) which can be secured.

Accordingly, in its broader aspects, the invention relates to a cable tie mount for routing wires or cables comprising an elongated rail portion; and at least one mounting stub at least one end of the rail portion, at least one mounting stub extending substantially perpendicularly of the rail portion, at least one mounting stub adapted for connecting the cable tie mount to a supporting surface.

In another aspect, the invention relates to a cable tie mount and panel assembly comprising at least one panel having a flat surface; at least one cable tie mount comprising an elongated rail portion; and at least one mounting stub at least one end of said rail portion, at least one mounting stub extending substantially perpendicularly of the rail portion, wherein the at least one mounting stub is secured to the flat surface of the panel.

The invention will now be described in greater detail in conjunction with the drawings described below.

### BRIEF DESCRIPTION OF DRAWINGS

FIG. 1 is a side elevation of a cable tie mount in accordance with the invention;

FIG. 2 is a front elevation of the cable tie mount in FIG. 1;

FIG. 3 is a perspective view of a cable tie mount in accordance with the invention, with cables secured thereto; and

FIG. 4 is a perspective view of a more comprehensive installation utilizing cable tie mounts of different lengths.

### DETAILED DESCRIPTION

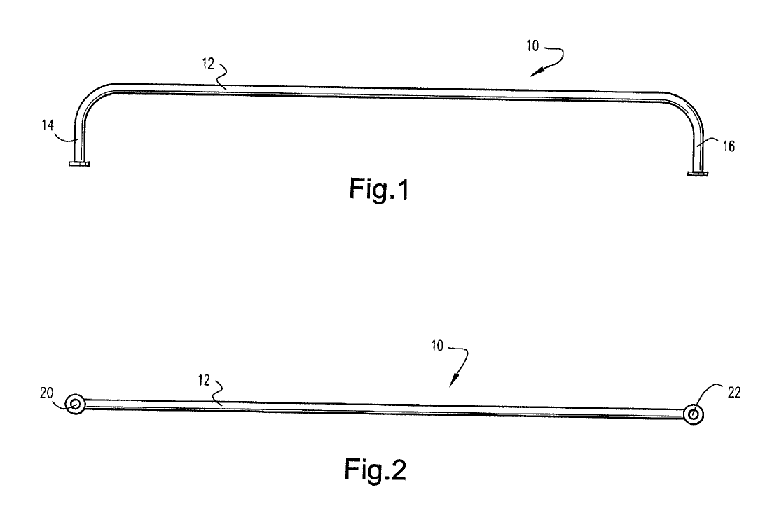

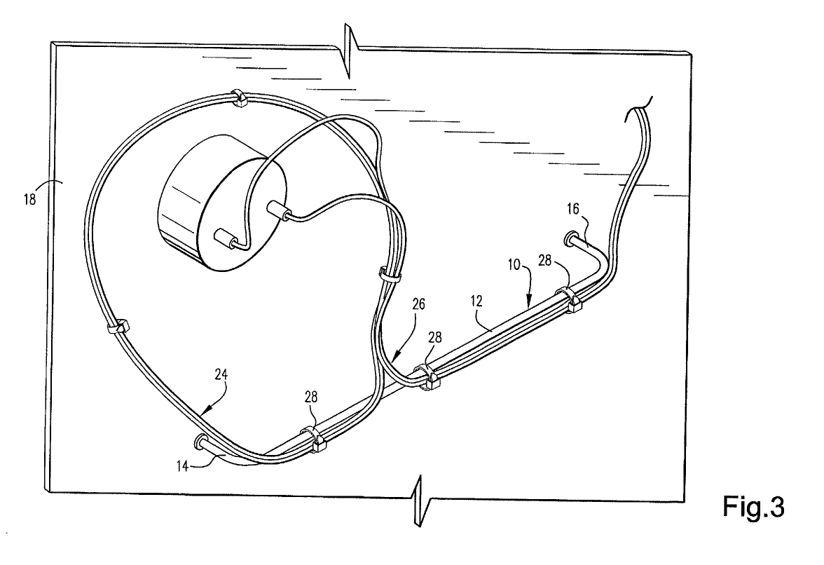

With reference to FIG. 1, a cable tie mount 10 in accordance with an exemplary embodiment of the invention includes an elongated rail portion or rail 12 that may be metal, plastic or other suitable relatively rigid tubular material, preferably of round cross section. Bar stock may also be utilized. The rail 12 terminates at opposite ends at mounting stub portions or stubs 14, 16 that extend substantially perpendicular to the rail 12. These opposite ends of the tubing may be internally threaded to permit securement of the cable tie mount to an electrical panel, internal surface of a panel box door or the like. Alternatively, and especially when the cable tie mount is made of solid bar stock, the cable tie mount may be fusion welded to the supporting surface at the mounting stubs 14, 16. The stubs 14, 16 are of sufficient length to space the rail away from the supporting surface, but may be of any desired length. Likewise, the rail 12 may be of any desired length, as dictated by specific uses of the cable tie mount.

It will be appreciated that if the rail 12 is sufficiently short, only one mounting stub 14 or 16 could be incorporated into the cable tie mount design.

FIG. 3 illustrates the manner in which the cable tie mount 10 may be utilized on a flat panel surface 18. Specifically, the cable tie mount is secured to the surface 18 by screws threaded into the stubs 14, 16 at 20, 22, inserted from the opposite side of surface 18. Two pairs of cables 24, 26 are routed along the rail 14, with conventional cable ties 28 enclosing the cables and wrapped about, and secured to the rail. It will be appreciated that as few as one or two, and as many as several wires or cables may be routed along the rail 14. Note that the cables can generally surround the round rail if necessary, and the stubs 14, 16 can be lengthened as necessary to create additional space as desired.

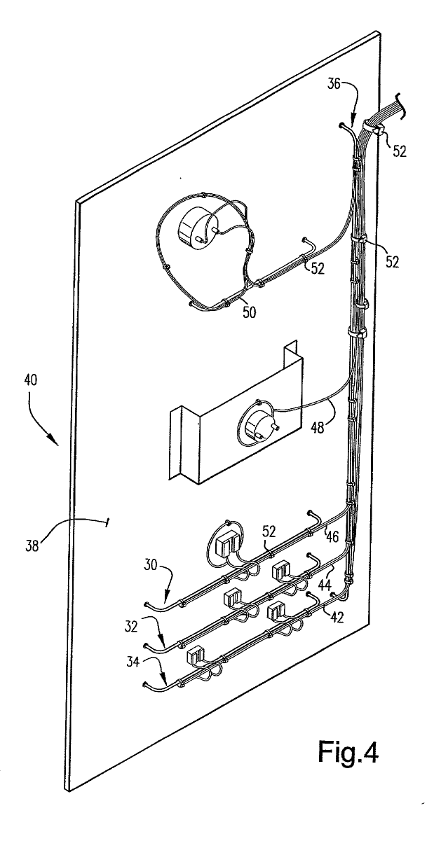

FIG. 4 illustrates a more comprehensive installation with three horizontally oriented cable tie mounts 30, 32, 34, similar to cable tie mount 10, and a longer, vertically oriented cable tie mount 36 secured to the inside surface 38 of an electrical box door 40 to which various respective cables or cable bundles 42, 44, 46, 48 and 50 are secured by conventional ties 52. The ability to make rails of different lengths, shapes, etc. and to orient the rails as needed, imparts great flexibility and ease of use to the cable tie mount system in accordance with the exemplary embodiment of the invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A cable tie mount for routing wires or cables comprising:
an elongated rail portion; and at least one mounting stub at least one end of said rail portion, said at least one mounting stub extending substantially perpendicularly of said rail portion, said at least one mounting stub adapted for connecting said cable tie mount to a supporting surface.

2. The cable tie mount of claim 1 wherein said at least one mounting stub is internally threaded.

3. The cable tie mount of claim 1 constructed of metal or plastic tubing.

4. The cable tie mount of claim 1 constructed of bar stock.

5. The cable tie mount of claim 1 wherein at least said rail portion is round in cross section.

6. The cable tie mount of claim 1 wherein said at least one mounting stub comprises a pair of stubs at opposite ends of said rail portion, and wherein said rail portion and said mounting stubs are generally U-shaped.

7. The cable tie mount of claim 1 in combination with one or more cable ties.

8. A cable tie mount and panel assembly comprising;
at least one panel having a flat surface;
at least one cable tie mount comprising an elongated rail portion; and at least one mounting stub at least one end of said rail portion, said at least one mounting stub extending substantially perpendicularly of said rail portion, wherein said at least one mounting stub is secured to said flat surface of said panel.

9. The assembly of claim 8 including a second cable tie mount secured to said flat surface of said panel in spaced relationship to said at least one cable tie mount.

10. The assembly of claim 9 wherein said at least one cable tie mount and said second cable tie mount are located adjacent and parallel to one another.

11. The assembly of claim 10 and further comprising at least a third cable to mount extending substantially perpendicularly to said second cable tie mount.

12. The assembly of claim 9 including cables routed along said at least one cable tie mount and along said second cable tie mount.

13. The assembly of claim 11 including cables routed along said at least one cable tie mount, said second cable tie mount and said third cable tie mount.

14. The assembly of claim 12 wherein said cables are secured to said at least one cable tie mount and said second cable tie mount by cable ties.

15. The assembly of claim 13 wherein said cables are secured to said at least one cable tie mount, said second cable tie mount and said third cable tie mount by cable ties.

16. The assembly of claim 11 wherein said first, second and third cable tie mounts are round in cross section.
